(19) United States
(12) Patent Application Publication
(10) Pub. No.: US 2008/0135564 A1
(43) Pub. Date: Jun. 12, 2008

(54) CONTAINER FOR SHIPPING PRODUCTS, WHICH CONTROLS TEMPERATURE OF PRODUCTS

(76) Inventor: Benjamin Romero, Edison, NJ (US)

Correspondence Address: Walter J. Tencza Jr.;Suite 210, 100 Menlo Park, Edison, NJ, 08837, US

(21) Appl. No.: 11/609,564

(22) Filed: Dec. 12, 2006

(51) Int. Cl. B65D 81/38; B65D 21/00; H05B 1/00

(52) U.S. Cl. 220/592.2; 206/499; 219/386

(57) ABSTRACT

An apparatus is disclosed for shipping temperature sensitive products at a temperature of two to eight degrees Celsius for long shipment durations with maximum reliability and minimum cost. The apparatus may include a first container and a second container. The first container may include one or more heating devices which direct heat into a first chamber. The first container may fit into a second chamber of the second container. The second container may include one or more liquid and/or frozen packets.

### FIELD OF THE INVENTION

This invention relates to improved methods and apparatus concerning keeping products at a specified temperature range during shipment.

### BACKGROUND OF THE INVENTION

There exists a big need for safely and reliably shipping sensitive pharmaceutical products at low cost, especially at the two to eight degree Celsius range. When pharmaceutical companies are performing clinical trials to evaluate the performance of a new drug, they must ship small and large quantities of the drugs (depending on the stage of clinical trial) into patient's and doctor's offices. These end customers can be spread out around the world. In spite of this, and to eliminate possible variables out of the clinical trial process, the shipments for most biologics must typically maintain a temperature of between two to eight degrees Celsius until further stability testing is performed to allow for the drug to be exposed to other temperatures without negative effects. Therefore there is a big market for shipping of biologics during clinical trials.

For drugs that are finishing clinical trials, or on their way to United States Food and Drug Administration (US FDA) approval and subsequent launch, or during post launch production, there is also a strong need for reliable and accurate shipping methods in the two to eight degrees Celsius temperature range, most especially when stability studies for the drug show that the drug must be maintained at two to eight degrees Celsius at all times. Therefore, there is a clear need outside of the clinical trial market to provide such shipping technology and methods. These shipping methods could involve shipments to a patient or a wholesaler, in unit quantities or in bulk, from the manufacturing site or from a distribution center or wholesaler.

The following is a review of known prior art shipping technology:

(1) Passive Shippers:

Passive shippers use a material's physical property that when a material changes from solid to liquid and vice versa (for example ice to water and vice versa), the material's temperature does not change while it absorbs or releases energy due to external/internal temperature differential. The material is often called a phase change material (PCM). This is how ice is able to maintain a beverage cold, by absorbing heat from the beverage (which itself is absorbing heat from the environment or the user's hand) while it turns into a liquid (at zero degrees Celsius/thirty-two degrees Fahrenheit). This is also how commonly available water based gel packs or packets are able to maintain temperatures near zero degrees Celsius inside of an insulated lunch box or camping cooler.

The term “passive” is used in “passive shippers” because these types of systems are only able to maintain one temperature (the phase change temperature, such as for example zero degrees Celsius) and only in one direction per phase change condition. In this way a frozen block of ice can only maintain zero degrees Celsius and protect against a temperature differential that is above the phase change temperature of the material (zero degrees Celsius or above). For example, a frozen block of ice cannot maintain zero degrees Celsius when exposed to a temperature below zero degrees Celsius, say for example negative twenty degrees Celsius (i.e. Minnesota in the winter). Using frozen ice to protect a product that cannot be exposed to negative twenty degrees Celsius would not be advisable because no phase change will occur in the ice from zero degrees Celsius to negative twenty degrees Celsius.

The same frozen block of ice can protect a product that must be at zero degrees Celsius against warm temperatures, for a time period, because melting occurs at zero degrees Celsius, and the temperature of zero degrees is maintained during the time period while the ice melts.

These “passive” systems are not able to adjust to outside temperatures in order to maintain the appropriate temperature range.

An example of this would involve a product that needs to be maintained between negative ten degrees Celsius and ten degrees Celsius. If only frozen ice were used in a passive shipping system, we could only protect against going over ten degrees, and for a certain amount of time (the time it takes the ice to melt). For example, frozen ice may be effective in the summer, where an ambient temperature of thirty degrees Celsius would try to warm the product. However, the frozen ice does not protect against a negative ten degree temperature.

An option to overcome this problem could be to combine frozen ice with liquid water, in the same shipping container. Because both liquid water and frozen ice will equilibrate at zero degrees Celsius (thus no temperature differential, therefore no heat transfer and no change in temperature, for the time period while melting or freezing occurs) we will have accurate maintenance of zero degrees Celsius, for a certain period of time, in both winter and summer environmental conditions. This is a very cost effective and efficient way of accurately maintaining zero degrees Celsius inside of a shipper. However, the fact that a frozen and refrigerated water shipper is excellent for zero degrees Celsius means that it is not suitable for a range of two to eight degrees Celsius since this range is above or outside zero degrees Celsius.

Several types of passive shippers are commonly available today for shipping refrigerated products, using varied phase change material approaches:

(a) Water based PCM (phase change material) gel packs or packets: An insulated shipper with a passive water based PCM as a means of maintaining a constant temperature inside of a payload chamber. The advantages of water based PCM gel packs or packets are lowest cost, lowest toxicity and minimal environmental impact (disposability). Water based PCM gel packs can be easily gelled to prevent leakage during puncture and make the gel pack more rigid. The disadvantages of water based PCM gel packs are an inability to adjust to changing outside environment (because they are passive shippers), and very poor temperature accuracy outside of zero degrees Celsius. These gel packs are usually tested against standard temperature profiles that simulate twenty-four, forty-eight, seventy-two, or ninety six hours environmental conditions for worst case winter and summer conditions. Water based PCM gel packs are typically limited to ninety-six hours in shipping length (before the temperature starts to deviate from zero degrees Celsius).

The problem with this type of shippers arises from the fact that water changes phase at zero degrees Celsius (thirty-two degrees Fahrenheit), which is too low for pharmaceutical products and can lead to freezing of the product. This is usually helped by the addition of a buffer component between the zero degrees Celsius frozen water based gel pack and the product (which requires a temperature of two to eight degrees Celsius), such as refrigerated water based gel packs or bubble wrap, or the introduction of an air gap to avoid the freezing of the delicate product. These buffer components add to the size, weight, and cost of the shippers, and do not address the underlying problem with the shippers, which is their inability to actively adjust the temperature based on internal and external temperature differentials. Cold Chain Technologies (trademarked), and TCP Reliable (trademarked) are manufacturers of systems including water based PCM gel packs along with buffer components.

(b) Custom PCM Packs: An insulated passive shipper with a passive custom PCM as a means of maintaining a constant temperature inside of the payload chamber. A custom PCM is a chemical, other than plain water which is chosen for its freeze and melt point to maintain a temperature other than zero degrees Celsius, the freeze and melt temperature of water. Custom PCM packs are advantageous in that they provide mid-level relative material cost; they are less expensive than active shippers (which will be described), but much higher than water based PCM shippers. Custom PCM packs are disadvantageous in that they cannot adjust to outside environment (because they are passive shippers), and they have very poor temperature accuracy. Custom PCM packs usually have a much lower (half or less) heat of fusion (amount of energy required to melt or freeze a quantity of mass of material, or how long the material will maintain a certain temperature or ‘last’) when compared to water. This means that there is much less energy involved in the freezing and melting process, and therefore it will take a lot more mass of custom PCM than it would of water based PCM, which in turn means that the overall scale of the shipper will be larger and heavier.

Custom PCM packs are usually tested against standard temperature profiles that simulate a shorter shipment's environmental conditions for worst case winter and summer conditions. Custom PCM packs are limited to typically less than 72 hours in shipping length. Cold Chain Technologies (trademarked), and TCP Reliable (trademarked) are manufacturers of systems including Custom PCM packs and buffer components.

U.S. patent application publication no. 20050031809, inventor Benjamin Romero, titled “Thermal Packaging System”, and incorporated by reference herein; describes a system using a Custom PCM which phases at approximately five degrees Celsius and thus is able to maintain a temperature between two and eight degrees Celsius. A problem with the Custom PCM described in that patent application is that phasing properties are subject to chemical lot variations and in the best of cases freezing and melting performance differ greatly. Most PCM's are subject to supercooling variation (freeze point depression by which the PCM has to reach a temperature lower than its freezing point for crystallization to begin, and thus phase change) during freezing (including water, albeit much less pronounced). A typical five degrees Celsius custom PCM (chemical freezing at five degrees Celsius) would usually be consistent at freezing in the three to six degree Celsius range. Melting properties of most custom PCM materials offer a less powerful melting curve and at a higher temperature than during freezing, for example in the five to nine degree Celsius range for that same five degrees Celsius custom PCM.

In summary the aforementioned published patent application describes a shipper which uses mainly a custom phase change material with the use of insulation to assist in reducing heat transfer into and out of the shipper's payload.

(2) Active Shippers:

Active shippers are able to adjust to external environmental conditions which are above and below the temperature range which is trying to be achieved, and maintain a desired internal temperature. There are several approaches with these systems:

(a) Compressor driven: An electrical compressor driven shipper works similarly to a common household air conditioning unit or a heat pump air conditioning/heating device for accurately maintaining a set temperature. Compressor driven systems can accurately maintain a user selected temperature. These systems can work with larger size shippers. However, compressor driven systems have high energy requirements. These systems usually need to be plugged in to a power source. This is undesirable when shipping to remote or third world locations and in the event of a power failure. Air transport is not usually able to readily supply power outlets for such systems. Compressor driven systems are also the largest, heaviest and most expensive.

(b) Peltier based devices: Peltier (thermoelectric) based devices are electrical devices which are able to cool and heat depending on the polarity of the electrical current applied to them. These types of devices have the ability to accurately control temperature by heating and cooling. They only need electricity to operate in both heating and cooling mode by means of a controller which can switch polarity. However, Peltier based devices are very expensive and require a great deal of energy to operate with big temperature differentials. The devices are delicate and can break easily. The bigger they are, the more expensive they are, and typically they are prohibitive in cost for larger shippers.

(c) Heater devices: Heater devices are electrical devices which are able to provide heat work in a manner similar to common household heaters. Temperature control in these devices is provided by means of a thermostat. Heater devices have an ability to control temperature accurately by means of this thermostat. However, heater devices can only protect a product from temperature changes when the external temperature is below the desired payload temperature. These devices do not have the ability to provide cooling. U.S. Pat. No. 6,028,293 titled “Temperature-controlled container with heating means ” and incorporated by reference herein, discloses a heater device of the prior art.

(3) Combination Active and Passive Shippers

Combination Active and Passive Shippers combine the power of phase change with the accuracy and reliability of electronic or mechanical controls.

(a) An example of a combination active and passive shipper is a dry ice and thermostat controlled forced air system. For example, Envirotainer (trademarked) has such as system. The Envirotainer system uses a chest of dry ice (high energy absorbing process of dry ice sublimation) combined with a thermostat controlled fan to provide cooling to a product payload. The Envirotainer system has medium to high accuracy in maintaining cool temperatures. However, it can only protect a product when external temperature is above the desired payload temperature. The system is not able to provide heating. In addition, because of the bigger temperature differential between the sublimation temperature of dry ice (approx. negative eighty degrees Celsius) and the outside environmental temperatures, the advantage of the high energy capacity of dry ice is somewhat offset by the increase in heat transfer rate due to the higher temperature differential. Dry ice is a hazardous substance which displaces oxygen and its low temperatures make it difficult to handle safely and effectively.

(b) Another example, of a combination active and passive shipper is a water based PCM pack with mechanical thermostat control system. Kodiak (trademarked) makes a system of this type. This type of system combines water based phase change material with a mechanical conduction thermostat system to actively adjust the influence of the frozen water based PCM on the payload chamber temperature for temperature control. Such as system has medium to high accuracy in maintaining a desired temperature range. However, this system has a high expense due to the complicated mechanical thermostat system and required use of vacuum insulated panels to provide enough insulation for the device to be effective. Vacuum panels are also delicate components that need to be protected from puncture, by means of expensive protection, which makes the system best suited for multiple/repeated use, but not very cost effective for single use. Because this system usually uses a single thermostat (because of its expense), it is hard to properly control temperature within all corners of the shipper. A great disadvantage of such a device is the inability to provide heating and thus protect payload from exterior environmental temperatures lower than the desired internal payload temperature. A water based PCM pack with mechanical thermostat control system is disclosed by U.S. Pat. No. 7,057,527 titled “Insulated Container” and U.S. Pat. No. 6,771,183, titled “Advanced Thermal Container, both of which are incorporated by reference herein.

(c) Another example, of a combination active and passive shipper is a heater based system with custom PCM. This type of system uses a heater (to provide heating) aided by a custom PCM to provide cooling (from the PCM since it is in a frozen state) inside of a payload chamber or cavity. This system is intended for use with products which need to maintained at room temperature. This type of system has the accuracy of a thermostat controlled battery powered heater to protect from cooler temperatures and adds additional protection by using a frozen PCM that phases at the high end of the temperature range so that some protection from hotter temperatures is provided. However, the system heating capacity comes from the batteries only and when exposed to high temperature differentials (if for example it is trying to maintain room temperature and is exposed to negative twenty degrees Celsius winter shipping conditions) it will only maintain a desired temperature for a short amount of time. The system has limited cooling capacity, and has poor temperature accuracy, especially since the melting phase of a custom PCM is less stable than the freezing phase.

U.S. Pat. No. 6,020,575 to Nagle, incorporated by reference herein discloses such a combination of active and passive shipper technology. Nagle provides an insulated shipper with heater and eutectic pack. This shipper is designed for products which need to be maintained at room temperature. The PCM and the heater are in the same chamber because the PCM is selected for its ability to maintain a temperature within the desired product temperature range.

Prior PCM based (passive) shippers are typically designed to maintain a temperature between two to eight degrees Celsius under either winter or summer conditions (but not both), which means that a different shipper package configuration needs to be employed in each season. This often brings up the issue of having to determine when to use a winter packout and when to use a summer packout, especially in the Spring and Fall seasons. This is a major drawback of most passive systems. Depending on the product and shipping routes, a year round shipping configuration can be designed, however this usually means a very large and costly shipper. This is usually not an issue with active shippers that can cool and heat, but they are very costly and large.

The prior art provides options for maintaining temperature control inside of a transport shipper, but as explained above, they have their own shortcomings and they are not able to provide a solution for maintaining a product temperature at between two and eight degrees that is accurate, adjusts to changing and extreme internal and external temperatures (active control) and that is light, small, and economical.

### SUMMARY OF THE INVENTION

One or more embodiments of the present invention provide a novel method for shipping of refrigerated (two to eight degrees Celsius) products (such as pharmaceutical drugs), which provide high accuracy, small size, and low cost when compared to existing methods.

In one embodiment an apparatus is provided including a first container having a first chamber and a second container having a second chamber. One or more packets are located within the second chamber. The first container includes a first heating device which projects heat into the first chamber. The one or more packets may include a material in a frozen and/or a liquid state. The first container can be put in a closed state and in the closed state can be placed within the second chamber of the second container with the first packet.

In one embodiment, the first container has a bottom, a first wall, a second wall, a third wall, a fourth wall, and a lid, which together, when the first container is in the closed state, define the first chamber. The second container has a bottom, a first wall, a second wall, a third wall, a fourth wall, and a lid, which together when the second container is put in a closed state, define the second chamber.

The packets may include water. The first container may be an insulator, which may be made of expanded polystyrene. The second container may be an insulator, which also may be made of expanded polystyrene. A plurality of heating devices may be provided, each of which may be located on an internal surface of one of the bottom, first wall, second wall, third wall, fourth wall, and lid, and projects heat into the first chamber. Each of the heating devices may be a flexible film heater. A battery may be provided for powering the heating device. The apparatus may maintain a temperature inside the first chamber of between two and eight degrees Celsius.

A pharmaceutical product may be located within the first chamber. The apparatus may be further comprised of an airspace between the pharmaceutical product and the first container so as to promote free convection within the first chamber and reduce stratification. The first container may contain ridges or spacers in its inside walls to separate the product from the heater, so as to allow the air within the first container's chamber to mix properly by free convection. The apparatus may be further comprised of an airspace between the packet or packets and the first container so as to promote free convection within the second chamber and reduce stratification. The first container may also contain ridges or spacers to separate its outer walls from the packet or packets to prevent the packet or packets from contacting the first container's outer walls so as to allow the air within the second container's chamber to mix properly by free convection.

One embodiment of the present invention includes a method involving placing a product in a first chamber of a first container, closing the first container to form a closed first container, with the product inside the first chamber, placing a first packet into a second chamber of a second container, placing the closed first container into the second chamber of a second container, so that the first packet faces an outside portion of the closed first container, closing the second container to form a closed second container, with the closed first container inside the second chamber, and shipping the closed second container.

### BRIEF DESCRIPTION OF THE DRAWINGS

FIG. 1 shows a perspective view of a product for shipping;

FIG. 2 shows a perspective view of a first container for shipping the product of FIG. 1;

FIG. 3 shows a perspective view of a second container for shipping the product of FIG. 1;

FIG. 4 shows a perspective view of an apparatus including the product, first container, and second container of FIGS. 1-3;

FIG. 5 shows a top view of a heating liner or pad component which can be placed in the container 100 of FIG. 2, after the heating pad or liner has been folded outwards into a flattened form, along with circuitry including a thermostat, and a battery;

FIG. 6 shows a cross sectional view of the apparatus of FIG. 4, with the apparatus in a closed state; and

FIG. 7 shows a perspective view of another embodiment of a container which can be used in accordance with the present invention

### DETAILED DESCRIPTION OF THE DRAWINGS

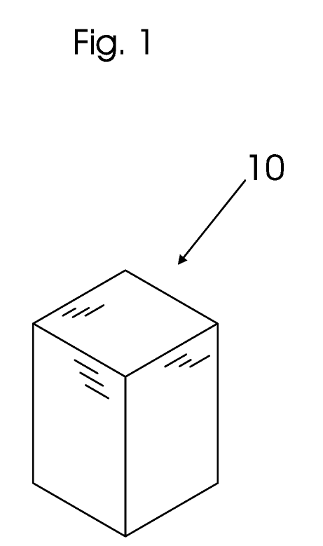

FIG. 1 shows a perspective view of a product 10 for shipping. The product 10 may include a box of pharmaceuticals which typically need to be kept at a temperature of two to eight degrees Celsius.

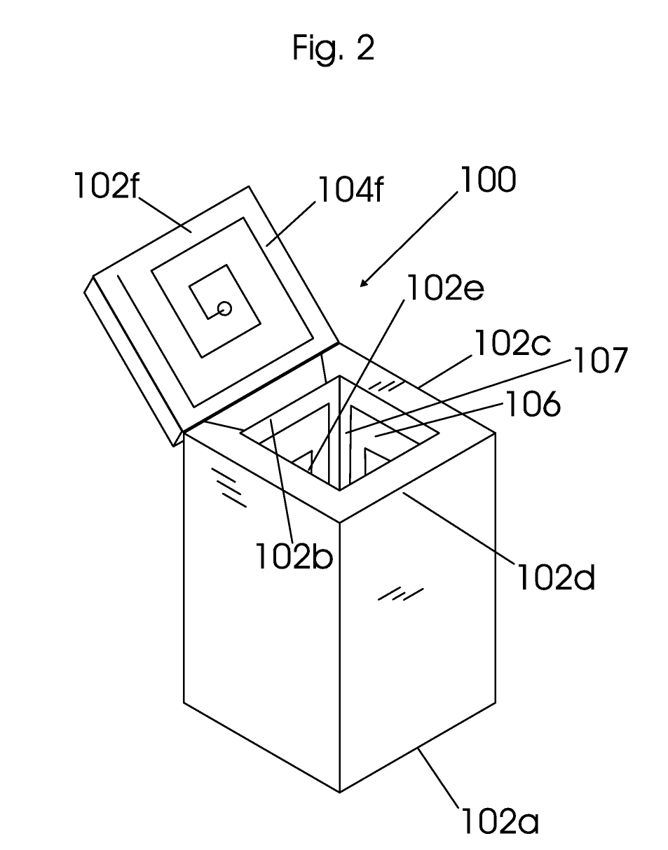

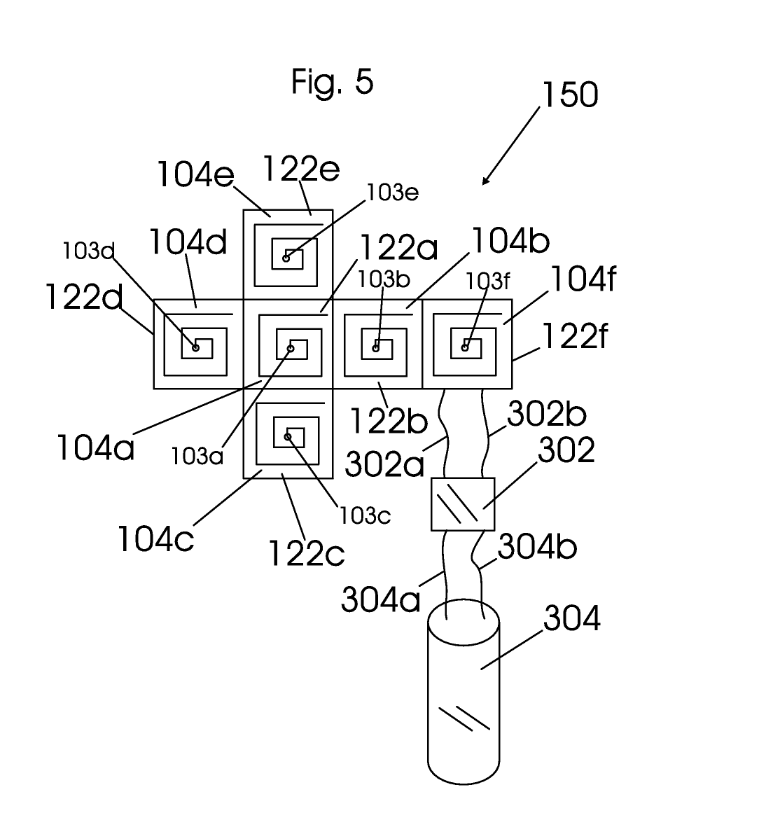

FIG. 2 shows a perspective view of a first container 100, into which the product 10 can be inserted. The first container 100 includes bottom 102a, side walls 102b, 102c, 102d, and 102e, and lid 102f. The walls of an insulated shipping container are typically made of standard materials such as expanded polystyrene (EPS) or urethane. When the lid 102f is closed, the lid 102f, bottom 102a, and side walls 102b-e substantially enclose a chamber or cavity 106, into which the product 10 can be inserted by means of lid 102f. Heating elements 104a, 104b, 104c, 104d, 104e, and 104f are located on 102a-102f, respectively, as shown in FIG. 5. The heating elements 104a-f face towards the chamber or cavity 106 so that they can face towards the product 10 when the product 10 is inserted into the chamber or cavity 106.

FIG. 5 shows a top view of the heating devices or elements 104a-f when provided on a foldable liner 150, which can be placed inside the chamber 106 of the first container 100, along with circuitry 302 and a battery 304. The foldable liner 150 may include sections 122a-f which can be aligned with bottom 102a, walls 102b-e, and lid 102f, respectively. The circuitry 302 is electrically connected to heating elements 104a-f via conductors 302a and 302b. The battery 304 is electrically connected to circuitry 302 via conductors 304a and 304b. The sections 122b-e of the liner 150 are attached to the section 122a and are able to fold with respect to the section 122a. The lid section 122f is attached to the sidewall section122b and is able to fold with respect to the sidewall section 122b.

The lid 102f allows for opening and closing of the container 100 to allow placement of product 10 within container's 100 payload chamber 106. Different embodiments in accordance with the present invention can have a single heating element or multiple heating elements included with the container 100.

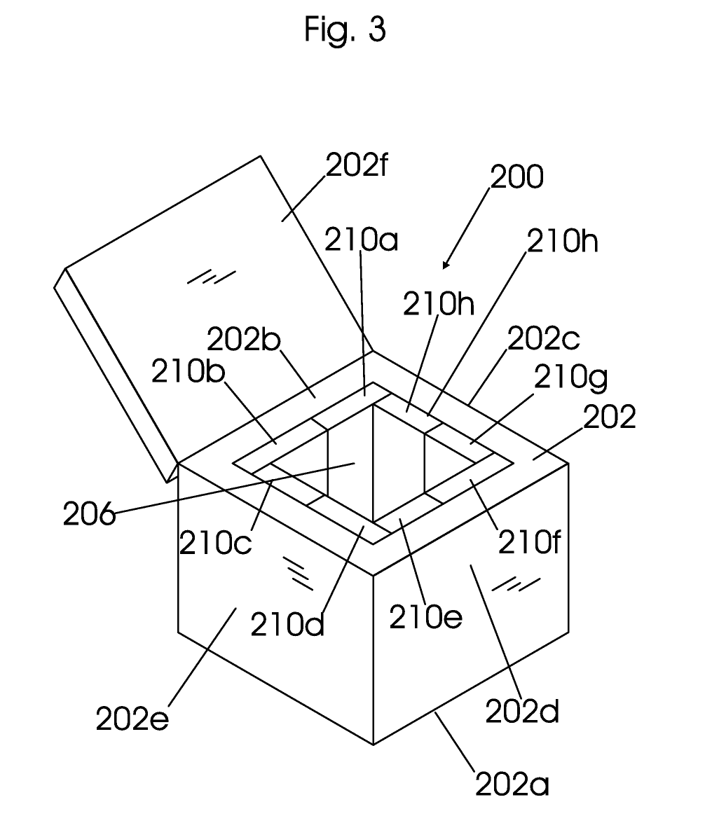

FIG. 3 shows a perspective view of a second container 200, into which the first container 100 can be inserted. The second container 200 has a bottom 202a, side walls 202b, 202c, 202d, and 202e, and a lid 202f. The walls of an insulated shipping container are typically made of standard materials such as expanded polystyrene (EPS) or urethane. The components 202a-f, when the second container is closed via lid 202f, enclose a chamber or cavity 206, into which the first container 100 has been inserted. The second container 200 may include or may have located therein liquid and/or frozen packs 210a, 210b, 210c, 210d, 210e, 210f, 210g, and 210h. The packs210a-210h may include a plastic sleeve or flexible or rigid sealed container in which water based PCM (in frozen, liquid or combination of frozen and liquid sate) is located. The chamber 206 is bounded by the packs 210a-210h.

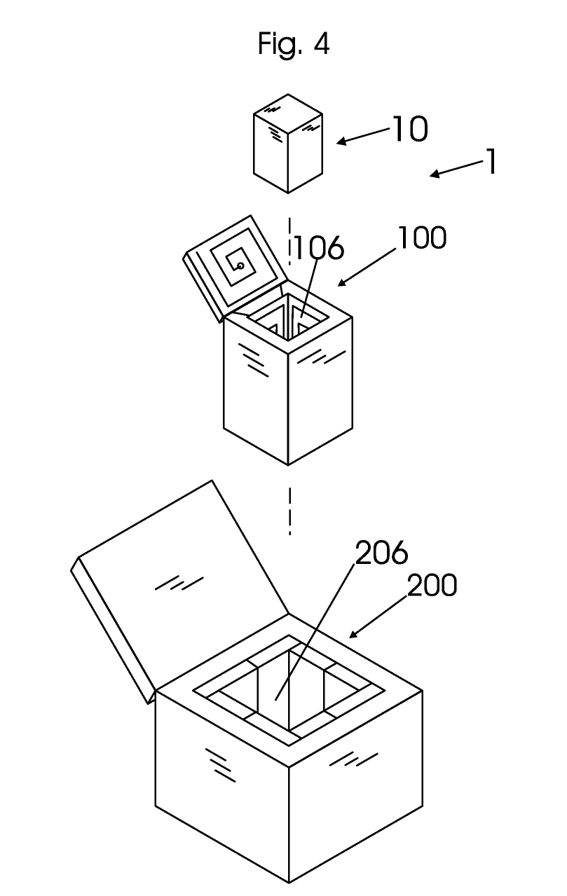

FIG. 4 shows a perspective view of an apparatus 1 including the product 10, the first container 100, and the second container 200 of FIGS. 1-3, respectively. The product 10 is typically inserted into the chamber 106 of the first container 100. The first container 100 (and the product 10 inside of the first container 100) is then inserted into the cavity or chamber 206 of the second container 200.

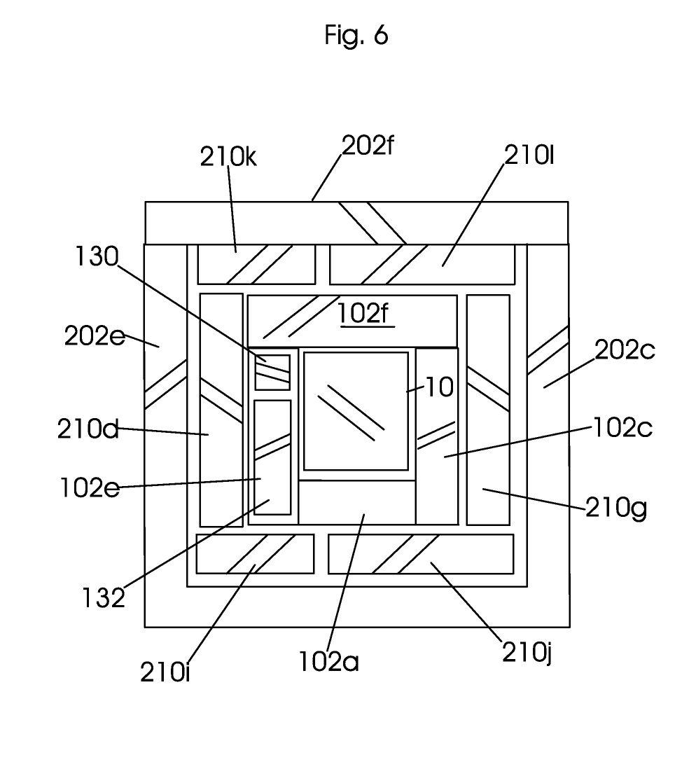

FIG. 6 shows a cross sectional view of the apparatus 1 of FIG. 4, with the apparatus 1 in a closed state. FIG. 6 shows controller 302 and battery pack 304 inside of side wall 102e of the first container 100. FIG. 6 also shows lid 202f, side walls 202c and 202e of the second container 200. FIG. 6 also shows packs 210i, 210j, 210k, 210l, 210d and 210g which contain water based PCM (in frozen, liquid or combination of frozen and liquid sate) to maintain zero degrees Celsius. FIG. 6 further shows side walls 102e, and 102c, bottom 102a, and lid 102f of the first container 100.

At least one embodiment of the present invention provides an insulated shipper container or apparatus 1 which is very efficient and very accurate and is able to provide a light, small, and economical means of accurately maintaining two to eight degrees Celsius in a prescribed product payload.

A system in accordance with one embodiment of the present invention, overcomes the problems of current technologies by uniquely arranging several components to achieve an ideal solution which uses commonly available components in a way that is powerful, accurate and relatively inexpensive. In one embodiment water is used as the main source of energy to maintain zero degrees within a chamber of the shipper. As discussed earlier, water is an ideal PCM (phase change material) in that it is very inexpensive, readily available, powerful and safe; also as discussed earlier, if necessary, water based PCM can be arranged in both frozen and liquid states within a chamber to effectively maintain zero degrees Celsius and protect against both hot and cold outside temperature exposure: protecting from hot temperatures (greater than zero degrees Celsius) and maintain zero degrees Celsius via frozen ice, and protecting from cold temperatures (below zero degrees Celsius) and maintain zero degrees via liquid water. The present invention in one or more embodiments provides an inner shipping container that is able to maintain two to eight degrees Celsius (in chamber 106) when the temperature it sees immediately outside of it (inside of chamber 206) is always zero degrees Celsius by means of heat from heating system 150.

Because zero degrees Celsius is relatively close to two degrees Celsius, it can be rationalized and calculated that for an electric device to maintain a two degree differential, it would not take a lot of energy. This being true, as it is, especially when insulation is placed between a zero degree chamber and a two degree chamber, then a common heating element, such as one or more of heating elements 104a-f, powered by a battery, such as battery 304, shown in FIG. 5, and controlled by a thermostat, such as part of circuitry 302 could provide enough energy for accurately maintaining two to eight degrees Celsius within the product chamber, such as in chamber 106 of first container 100 (for shipments lasting several days or longer). With the use of insulation also between the water based PCM layer or layers provided by packs 210a-210h and the outside environment, as is common nowadays, the shipper is assured maintenance of zero degrees Celsius within the water chamber, or chamber 206 of the second container 200 for long periods of time as well (several days or longer). In summary, a system in accordance with one or more embodiments of the present invention uses the brute force capabilities of water and matches it to the accuracy of an electronic heater to provide an elegant and cost effective solution for two to eight degree Celsius shipping applications.

The formulas and calculations described herein demonstrate this approach. Heat transfer by conduction is the main heat transfer mode for a shipping container and can be evaluated exclusively for a basic demonstration of the performance capabilities discussed. The conduction heat transfer formula in Table A can be used to evaluate the heat transfer between the zero degree Celsius water based PCM layer or layer of packs 210a-h and the container chamber 106 at slightly over two degrees Celsius.

TABLE A

| Formula for | Q = −k * A * ΔT/Δx | | | |
|---|---|---|---|---|
| Conduction | | | | |
| Heat transfer | | | | |
| English Units | (BTU/hr) | (BTU/ft hr F.) | (ft2) | (F./ft) |
| SI Units | (W) | (W/m K) | (m2) | (K/m) |
| Description | Rate of heat | Thermal | Cross | Temperature |
| | transfer | Conductivity | sectional | Differential/ |
| | | of insulation | Area of | insulation |
| | | | Heat | thickness |
| | | | transfer | |

For one embodiment, to be used in this calculation, the present invention, uses commonly available EPS (Expanded Polystyrene) insulation for container 100 walls 102a-f. The EPS insulation density is 1.8 pcf (pounds per cubic foot) which has a thermal conductivity value (insulation value) of 0.033 W/m K (watts/meters/degrees Kelvin). As an example, one can use a payload of 6×6×6″ (inches cubed), which yields 1.5 ft² (feet squared) or 0.14 m² (meters squared) of available surface area for conduction heat transfer, or the surface area of the internal surfaces or surfaces facing chamber 106 of bottom 102a, walls 102b-e and lid 102f of chamber 106. The temperature differential as discussed is between zero degrees Celsius and four degrees Celsius (conservative since most electronic systems can maintain ±1 Celsius with ease). The insulating layer or wall thickness of each of the bottom 102a, walls 102b-e, and lid 102f, can be chosen as two inches for this embodiment. With all the variables defined, Q is calculated to be 0.362 Watts. This is the rate of heat transfer that could be expected in this scenario with this type of insulation and this thickness and temperature differential. The next step is to find out what type of battery and what quantity of such batteries would be needed to supply power for extended periods of time. The following formula as shown in table B is to be used for this calculation.

TABLE B

| | |
|---|---|
| Formula | P = V * I |

| | | | |
|---|---|---|---|
| SI Units | (W) | (V) | (A) |
| Description | Power | Electric | Electric |
| | (electrical) | Potential | Current |

Since most batteries are designed for 1.5 V (volts) voltage delivery, this will be the value used for this example. Using the power value (or Q value) calculated from the heat transfer calculation, of 0.362 Watts, it can be easily calculated that the electric current will be 0.241 Amps or 241 mA (milliamps). For twenty-four hours of capacity the current is multiplied by twenty-four, or 5.79 Ahrs (amp hours) or 5794 mAhrs (milliamp hours).

Most battery manufacturers provide data for the mA Hours capacity that can be expected from their batteries, and while this data is provided for room temperature applications (i.e. twenty-five degrees Celsius) and one or more embodiments of the present invention may expose the battery (such as battery 304 of FIG. 5) to temperatures close to zero degrees Celsius (depending on exact placement of battery packs, such as position 102e of battery pack 304), a reference point can be obtained to assess the approach. Therefore the ideal placement of the battery 304 in FIG. 6 for summer shipping conditions would be as close as possible to the outside of the container 200 or within the outer edge of one of its walls 202a-202f (where outside temperature conditions are expected to be twenty-five Celsius or above) and as close as possible to the internal payload or product 10 shown in FIG. 1, during winter conditions (where outside temperature conditions are expected to be negative ten degrees Celsius or below), to assure that the batteries never see below zero degrees Celsius and are always exposed to the highest temperature possible. Placing the batteries in a zero degree temperature, as per the latter approach, may require the use of special low temperature batteries, which is not an issue since batteries are readily available for use in temperatures down to negative fifty-five degrees Celsius. A leading manufacturer is Tadiran (trademarked) batteries. In this scenario, even if the price of the battery pack is greatly increased, the overall cost effectiveness relative to the accuracy and flexibility of the shipper is still much better than any other available system. Table C, as follows, shows data for performance of common batteries:

TABLE C

| Battery Type | Capacity (mAhrs) | Typical Drain (mA) |
|---|---|---|
| D | 12000 | 200 |
| C | 6000 | 100 |
| AA | 2000 | 50 |
| AA Alkaline | 2700 | NA |
| AAA | 1000 | 10 |
| N | 650 | 10 |
| 9 Volt | 500 | 15 |
| 6 Volt Lantern | 11000 | 300 |

As can be seen from the chart above, a simple C battery (6000 mAhrs) could provide the required 5794 mAhrs for the battery 304, so that a twenty four hour shipment could be made. If the thickness of the wall's insulation of container 100 is increased, or the insulation material is improved (use of Urethane instead of 1.8 pcf EPS, or use of vacuum insulated panels) the required energy will be much less. For additional capacity, several batteries can be placed in parallel; the following chart or Table D shows the amount of batteries that would be needed for different time spans:

TABLE D

| | | QTY of Batteries Needed based on drain | | | |
|---|---|---|---|---|---|
| Battery Type | | Time Value (Hrs) | | | |
| (ROOM | 1.5 V | 24 | 48 | 72 | 96 |
| TEMP | Capacities | (Units or | (Units or | (Units or | (Units or |
| DATA) | (mA hrs) | Batteries) | Batteries) | Batteries) | Batteries) |
| Standard AA | 2000 | 2.9 | 5.8 | 8.7 | 11.6 |
| Standard | 2700 | 2.1 | 4.3 | 6.4 | 8.6 |
| Alkaline AA | | | | | |
| Standard C | 6000 | 1.0 | 1.9 | 2.9 | 3.9 |
| Standard D | 12000 | 0.5 | 1.0 | 1.4 | 1.9 |

Choosing commonly available commercial batteries at slightly higher voltages would also reduce the amperage and reduce the number of batteries needed. Using a Tadiran (trademarked) 3.6 V (volts) C battery will yield a current requirement of 100 ma (milliamps) and the battery quantity requirements are as follows, as shown in Table E, as follows, for the same scenario, but at zero degrees Celsius temperature:

TABLE E

| | | QTY of Batteries Needed based on drain | | | |
|---|---|---|---|---|---|
| Battery Type | 3.6 V | Time Value (Hrs) | | | |
| (ROOM | Capacities | 24 | 48 | 72 | 96 |
| TEMP | @ 0 C. | (Units or | (Units or | (Units or | (Units or |
| DATA) | (mA Hrs) | Batteries) | Batteries) | Batteries) | Batteries) |
| Tadiran C | 2500 | 1.0 | 1.9 | 2.9 | 3.9 |

As per the above table, even at zero degrees the Tadiran (trademarked) commercial C battery is able to provide about 2500 ma hrs (milliamp hours) which will provide enough power for about twenty four hours (per battery).

The electric heating elements 104a-104f may be controlled by a thermostat, such as part of circuitry 302 in FIG. 5, for example readily available high accuracy circuitry, such as that found in electronic temperature loggers, which incorporates temperature measuring sensor/s (i.e. thermistor/s) and are designed to keep the product payload 106 shown in FIG. 2 from getting below two degrees Celsius (i.e. maintaining a temperature of between two and eight degrees Celsius, but designed to stay on the low end of the temperature range to minimize the temperature differential and reduce the amount of energy required. For example if the accuracy of a cost effective system is ±1 degrees Celsius, then the system would be designed to maintain three degrees Celsius to ensure that the temperature never drops outside of the desired two to eight degree Celsius range.

The product payload container 100 has a lid 102f, which is insulated, which can be closed, preferably air tight (as would be easily achieved with a common, cheap molded EPS (Expanded Polystyrene, white foam molded cooler)). The container 100 typically contains the battery 304 and temperature control circuitry, including thermostat 302 (which can be single use or reusable). Container 100 is then placed inside of another, larger insulated shipping container 200 shown in FIG. 3. The container 200 has enough space to fit the product payload container 100 and water based gel packs (frozen, liquid or a combination of both) 210a, 210b, 210c, 210d, 210e, 210f, 210g, and 210h (which will maintain zero degrees Celsius). The larger container 200 also has a lid 202f (insulated).

One important aspect of the present invention lies in the locating of water based gel packs (frozen, liquid or a combination of both), such as 210a-210h outside of the insulated payload (surrounding as much as possible, preferably completely, the first container 100) and thus creating an approximately 2 Celsius temperature differential between the inside or chamber 106 of the first container 100 (product payload) and the inside or chamber 206 of the second container 200. During a summer shipment, frozen water based gel packs 210a-210h would absorb the energy that infiltrates the second, outer insulated shipping container 200 and thus maintain 0 degrees Celsius while they melt. Because of the small temperature differential between the first, inner container 100 the battery power required to maintain 2-8 Celsius inside of the inner container (payload) 100 is minimal and easily achieved by today's efficient and economical batteries and heaters. The heaters, such as 104a-f, could heat just one side of the package or product 10 or all six sides of the inner walls of the product 10; for greatest accuracy, each heater (of heaters 104a-f) could be able to individually heat as needed (one wall could be cooler depending on the coolant placement and depending on the outside temperature distribution outside of the second container 200) in order to further conserve battery power and provide consistent temperature within chamber 106 and product 10.

A lower cost version of an embodiment of the present invention could be custom designed for the product 10 payload, as opposed of capable of working with any payload like the previous embodiment. Since the heaters 104a-f are always going to be compensating (as long as there is enough ice and/or water available) for a constant delta T (difference in temperature between outside the container 100 and inside the chamber 106), a cheap unit could be designed for a certain constant current draw so that no thermostats are theoretically needed, while still providing high accuracy based on the constant and accurate phase temperature of water. This would further lower costs while still providing a very accurate shipper; this change would make the device an advanced passive shipper. Each shipper designed would be tuned and validated to determine the ideal current draw for each package in order to maintain two to eight degrees Celsius. Quality Assurance could check the current draw of each heater and certify it to work for that specific shipper and payload combination. In the same manner another embodiment of an advanced passive shipper could use a chemical heat source instead of an electric heater (for example, an exothermic reaction providing the previously calculated energy required to maintain two to eight degrees Celsius, such as a custom formulated air activated iron hand warming pack), or it could use a custom PCM phasing at five degree Celsius in order to maintain two to eight degrees Celsius within the first container's chamber.

Another embodiment of the invention would only use one heater preferably placed at the bottom of the product chamber, such as only for 104a corresponding to 102a, and provide ridges or spacers separating the heater from the product and providing a gap from the product 10 and the inner walls of 102a-f of the inner container 100 so as to promote free convection within chamber 106 (because of less dense hot air rising and initiating free convection). This approach would also be beneficial inside of the water based PCM chamber 206 which would allow not having to place gel packs, such as 210a-h, completely surrounding the inner cooler outer walls of 102a-f.

Batteries can be placed inside the first container 100 or its insulating walls (using low temperature batteries which are more expensive, but doing so yields a more accurate and flexible system when weather is unknown), or inside second container's 200 insulating walls (including bottom 202a, walls 202b-e, and lid 202f ) (using standard batteries, which is cheaper and yields good accuracy at low cost when shipping to hot climates only, not cold climates), depending on the shipping routes. An extremely inexpensive yet reliable battery could be used during warm and hot weather shipments by placing the battery pack near the exterior of the shipper, within container 200 insulated walls (including bottom 202a, walls 202b-e, and lid 202f), facing the outside of the apparatus or shipper 1 so as to expose the batteries to the warm environmental temperatures of summer, and not towards the inside surfaces of bottom 202a, walls 202b-e, and lid 202f of container 200 so as to not expose the batteries to the zero Celsius temperature of the water based PCM in chamber 206.

An embodiment of the invention which would yield a shipper for year round use, meaning one single packout and not two different packouts (summer packout and winter packout) would use both refrigerated and frozen water based PCM in gel packs 210a-h. This could be achieved by a single layer of water based PCM as depicted in FIG. 3 or by using two layers (one layer using refrigerated and another using frozen or by a combination of frozen and refrigerated within both layers). An important part of this embodiment of the invention is that a water based PCM layer is within chamber 206 which can be comprised of frozen water based PCM, refrigerated water based PCM or a combination of the frozen and refrigerated PCM in a single or multi layer configuration as needed by the distribution lane that the shipper is being used in.

Efficiency of heater and control system may increase capacity requirement for battery capacity, but should not affect calculations significantly.

As battery efficiency increases (this may be more applicable to future embodiments, but could be accomplished now, although may not be most efficient), the heating system, such as 104a-f, powered by the batteries can also protect from low temperature spikes by itself, and then refrigerated packs would not be needed in chamber 206 to prevent chamber 206 from reaching temperatures below zero degrees Celsius during winter shipments. So it is possible in accordance with an embodiment of the first invention to have a year round shipper which only uses frozen water (ice) and the heater system (with the same insulation) to protect from both cold and hot environmental temperatures.

The first container 100 and the second container 200 may be single use or disposable, or may be of a reusable nature for all or some of the components. The battery (or batteries) 304 may be single use or reusable. The heating devices or elements 104a-f may be controlled by a single or multiple temperature sensors which may be located in circuit 302 shown in FIG. 5. Such single or multiple temperature sensors may include memory and may have the capability of recording measured temperature data for later or immediate retrieval. Such single or multiple temperature sensors may have the capability of displaying an alarm status if the internal temperature is outside a predetermined temperature range

A temperature alarm in the form of an LED (light emitting diode) could be located in several areas depending on the location of the battery pack and controller and based on customer preference. However the location should be visible and prominent so as to quickly alert the user if necessary. A location that would satisfy these requirements is on the heater circuitry, for example on container 100, inner surface of lid 102f or inner surface of liner section 122f (towards chamber 106) so that the user evaluates the alarm condition (LED on or blinking) upon opening of the lide 102f of the container 100. Another convenient and more economical location for the alarm would be immediately on the controller 302, so as to be as close as possible to the controller 302, since it is the controller 302 which would also house the alarm and data logging circuitry. The controller 302 should then be placed within walls 102b-e of the container's 100, near an opening 107, shown in FIG. 2, leading to chamber 106 so as to be seen upon opening of lid 102f of the container 100.

The heaters could be controlled by a single or a plurality of controllers and by a single or plurality of temperature probes. FIG. 5 shows six heaters, heating elements, or heating devices 104a-f, with temperature probes 103a-f (one at the center of each heater face, such as temperature probe 103a at center of heating device 104a) being controlled by a single multi-input controller 302. If a plurality of temperature controllers where built into each of the heater faces of heating devices 104a-f, next to the temperature probes 103a-f, there would then be a plurality of temperature probes and a plurality of temperature controllers, one near the center of each heater face. Additionally there could be a plurality of heaters controlled by a single temperature probe and controller. The location of a battery pack 304 is very significant, the impact of having the battery pack towards the outside of container 200 or towards container 100 has been disclosed earlier, with the different locations having their own advantages and disadvantages and being suited for different applications and shipping temperatures. For at least one embodiment of the present invention, if the application allows placing the battery pack towards the outside of the shipper or outside container 200, such as on outside surfaces of 202a-f, where it will be exposed to warm temperature during summer shipments, then extremely inexpensive battery or batteries can be used for 304; on the other hand if winter shipments expecting temperatures below zero degrees Celsius are expected, the battery 304 will need to be placed near the container 100 (inside chamber 206, inside chamber 106 or inside container 100 walls 102a-f) so as to never expose the battery or batteries 304 to temperatures below zero degrees Celsius, with the understanding that most likely more expensive batteries that can operate at zero degrees Celsius will need to be used in this case. Once a choice of the relative position of the battery or batteries 304 is made based on the application, the specific placement of the battery or batteries 304 is a routine exercise to someone with packaging experience.

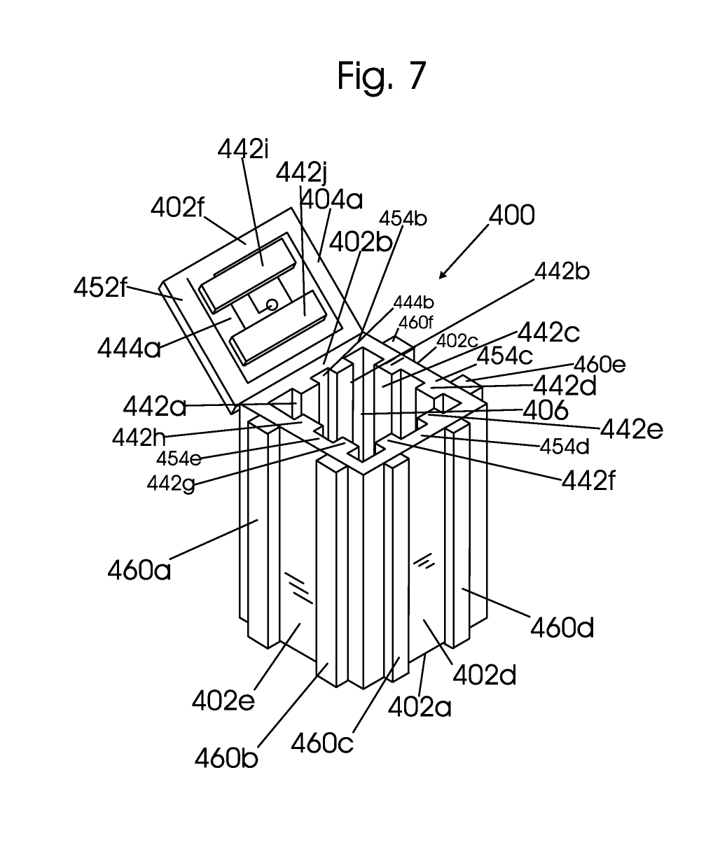

FIG. 7 shows a perspective view of a container 400 which can be used in place of the first container 100 in accordance with another embodiment of the present invention. The product 10 shown in FIG. 1 can be inserted into a chamber or cavity 406 of the container 400. The container 400, with the product inserted in the chamber 406 and the container 400 closed, can be inserted into the second container 200.

The container 400 includes bottom 402a, side walls 402b, 402c, 402d, and 402e, and lid 402f, each of which may be made of standard materials such as expanded polystyrene (EPS) or urethane. When the lid 402f is closed, the lid 402f, bottom 402a, and side walls 402b-e substantially enclose chamber or cavity 406, into which the product 10 can be inserted. The container 400 may include heating elements similar to heating elements 104a-f shown in FIG. 2, however, only one heating element 444a is shown for simplification. The preferred location for the heating element in this embodiment would be on 402a, because of hot air rising and promoting free convection.

The container 400 includes inner ridges 442a, 442b, 442c, 442d, 442e, 442f, 442g, 442h, 442i, and 442j. The ridges 442a and 442b are attached to or protrude out from an inner surface of wall 402b. There is a gap 444b between the ridges 442a and 442b. Similarly, the ridges 442c, and 442d protrude out from wall 402c, and there is a gap between ridges 442c and 442d; the ridges 442e and 442f protrude out from wall 402d, and there is a gap between ridges 442e and 442f; and the ridges 442g and 442h protrude out from wall 402e, and there is a gap between ridges 442g and 442h. There are also ridges 442i and 442j which protrude out from or are attached to lid 402f. The bottom 402a may also include ridges on its inner surface, towards cavity 406, similar to the lid 402f. The ridges 442i and 442j of the lid 402f are configured so that the lid 402f can close and an inner surface 452f of the lid 402f can come into contact with top edges 454b, 454c, 454d, and 454e of the walls 402b-402e, to provide a sealed chamber 406.

The heating element 444a in container 400 may lie on inner surface 452f of lid 402f and partially underneath ridges 442i and 442j. The ridges 442i and 442j can be glued, adhered to, or otherwise attached on top of part of heating element 444a and to the lid 402f. Heating elements may be provided for each of walls 402b-402e and bottom 402a, on inner surfaces facing chamber 406 in a manner similar to heating element 444a on lid 402f. The heating element 444a, and any further heating elements, faces towards the chamber or cavity 406 so that it can face towards the product 10 when the product 10 is inserted into the chamber or cavity 406.

The inner ridges 442a-442j and further inner ridges for bottom 402a not shown, provide an airspace (such as gap 442b and similar gaps between other ridges), between the product 10 and the lid 402f, bottom 402a, and walls 402b-e, so as to promote free convection within the chamber 406 and reduce stratification. I.e. when the product 10 is placed in the chamber 406, the product 10 comes in contact with the ridges 442a-442j but does not come in contact with the inner surfaces of bottom 402a, walls 402b-e, and lid 402f (such as inner surface 452f and similar inner surfaces facing chamber 406).

The container 400 may also include outer ridges 460a, 460b, 460c, 460d, 460e, and 460f shown in FIG. 7. Outer ridges 460a-b, 460c-d, and 460e-f project from and/or are attached to outside surfaces of walls 402e, 402d, and 402c, respectively. Similar outer ridges, not shown, may be provided on outer surfaces of bottom 402a, lid 402f, and wall 402b. The container 400 may include the inner ridges 442a-j and/or the outer ridges 460a-f. The outer ridges 460a-f and similar outer ridges can be implemented to separate the outer surfaces of walls, lid, and bottom (402a-f) of container 400 from the packet or packets 210a-h to prevent the packet or packets 210a-h from contacting the first container's outer walls, lid, and bottom (402a-f) so as to allow the air within the second container's chamber 206 to mix properly by free convection.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first container having a first chamber;
a second container having a second chamber;
a first packet located within the second chamber;
wherein the first container includes a first heating device which projects heat into the first chamber;
wherein the first packet includes a material; and
wherein the first container can be put in a closed state and in the closed state can be placed within the second chamber of the second container with the first packet.

2. The apparatus of claim 1 wherein
the first container has a bottom, a first wall, a second wall, a third wall, a fourth wall, and a lid, which together, when the first container is in the closed state, define the first chamber;
the second container has a bottom, a first wall, a second wall, a third wall, a fourth wall, and a lid, which together when the second container is put in a closed state, define the second chamber.

3. The apparatus of claim 1 wherein
the material is in a liquid state.

4. The apparatus of claim 1 wherein
the material is in a frozen state.

5. The apparatus of claim 1 wherein
the material is partially in a frozen state and partially in a liquid state.

6. The apparatus of claim 1 wherein
the material is water based.

7. The apparatus of claim 1 further comprising
a plurality of further packets located within the second chamber.

8. The apparatus of claim 7 wherein
each of the first packet and the plurality of further packets contains a water based material.

9. The apparatus of claim 1 wherein
the first container is an insulator.

10. The apparatus of claim 9 wherein
the first container is made of expanded polystyrene.

11. The apparatus of claim 1 wherein
the second container is an insulator.

12. The apparatus of claim 11 wherein
the second container is made of expanded polystyrene.

13. The apparatus of claim 2 further comprising
a plurality of further heating devices;
wherein each of the first heating device and the plurality of further heating devices is located on an internal surface of one of the bottom, first wall, second wall, third wall, fourth wall, and lid, and projects heat into the first chamber.

14. The apparatus of claim 1 wherein
the apparatus maintains a temperature inside the first chamber of between two and eight degrees Celsius.

15. The apparatus of claim 1 further comprising
a pharmaceutical product located within the first chamber.

16. The apparatus of claim 2 further comprising
wherein at least one of the bottom, lid, first wall, second wall, third wall, and fourth wall of the first container has an inner surface from which ridges project;
and wherein the product and the ridges are configured so that the product when located in the first chamber, comes in contact with the ridges but does not come in contact with the inner surface, so that there is an air space between the inner surface and the product when the product lies within the first chamber.

17. The apparatus of claim 16 wherein
the ridges prevent the product from coming into contact with the first heating device.

18. The apparatus of claim 1 wherein
the heating device is a flexible film heater.

19. The apparatus of claim 1 wherein
the heating device is an exothermic chemical reaction.

20. The apparatus of claim 1 wherein
the heating device is a custom phase change material phasing between two and eight degrees Celsius.

21. The apparatus of claim 1 further comprising
a battery which powers the heating device.

22. A method comprising
placing a product in a first chamber of a first container;
closing the first container to form a closed first container, with the product inside the first chamber;
placing a first packet into a second chamber of a second container;
placing the closed first container into the second chamber of a second container, so that the first packet faces an outside portion of the closed first container;
closing the second container to form a closed second container, with the closed first container inside the second chamber; and
shipping the closed second container;
wherein the first container includes a first heating device which projects heat into the first chamber; and
wherein the first packet includes a material

23. The method of claim 22 wherein
the first container has a bottom, a first wall, a second wall, a third wall, a fourth wall, and a lid, which together, when the first container is closed, define the first chamber;
the second container has a bottom, a first wall, a second wall, a third wall, a fourth wall, and a lid, which together when the second container is closed, define the second chamber.

24. The method of claim 22 wherein
the material in a liquid state.

25. The method of claim 22 wherein
the material is in a frozen state.

26. The method of claim 22 wherein
the material is partially in a liquid state and partially in a frozen state.

27. The method of claim 22 wherein
the material is water based.

28. The method of claim 22 further comprising
placing a plurality of further packets within the second chamber, prior to closing the second container, each of the plurality of further packets facing an outer portion of the first container.

29. The method of claim 28 wherein
each of the first packet and the plurality of further packets contains a water based material.

30. The method of claim 22 wherein
the first container is an insulator.

31. The method of claim 30 wherein
the first container is made of expanded polystyrene.

32. The method of claim 30 wherein
the second container is an insulator.

33. The method of claim 31 wherein
the second container is an insulator and is made of expanded polystyrene.

34. The method of claim 22 further comprising
a plurality of further heating devices;
wherein each of the first heating device and the plurality of further heating devices is located on an internal surface of one of the bottom, first wall, second wall, third wall, fourth wall, and lid, and projects heat into the first chamber.

35. The method of claim 22 further comprising
maintaining a temperature inside the first chamber of between two and eight degrees Celsius during shipping of the second closed container.

36. The method of claim 22 wherein
the product placed within the first chamber is a pharmaceutical product.

37. The method of claim 23 further comprising
configuring the product and the first container so that there is an airspace between the product and at least one of the bottom, the lid, the first wall, the second wall, the third wall, and the fourth wall of the first container has an inner surface from which ridges project so as to promote free convection within the first chamber and reduce stratification.

38. The method of claim 36 wherein
the ridges prevent the product from coming into contact with the first heating device.

39. The method of claim 22 wherein
the heating device is a flexible film heater.

40. The method of claim 22 wherein
the heating device uses an exothermic chemical reaction.

41. The method of claim 22 wherein
the heating device uses a custom phase change material phasing between two and eight degrees Celsius.

42. The method of claim 22 further comprising
placing a battery into the second container prior to closing the second container; and
wherein the battery powers the heating device.
